(19) United States
(12) Patent Application Publication
(10) Pub. No.: US 2015/0188765 A1
(43) Pub. Date: Jul. 2, 2015

(54) MULTIMODE GAMING SERVER

(71) Applicant: MICROSOFT CORPORATION, REDMOND, WA (US)

(72) Inventors: EUAN PETER GARDEN, Bellevue, WA (US); JOHN RAYMOND JUSTICE, Bellevue, WA (US); Madhu Sharma, Redmond, WA (US)

(73) Assignee: MICROSOFT CORPORATION, REDMOND, WA (US)

(21) Appl. No.: 14/145,915

(22) Filed: Dec. 31, 2013

(51) Int. Cl. H04L 12/24; A63F 13/35; G06F 1/32

(52) U.S. Cl. CPC H04L 41/0813; G06F 1/3234; A63F 13/35

(57) ABSTRACT

Aspects of the present invention relate to a multimode gaming server with different types of computing resources provided within the server. The different computing resources can be optimized for different computing tasks. For example, a first type of resource can be optimized for producing high definition graphics and a second type of resource for enterprise computing. Each resource may be activated or deactivated as demand for different computing tasks change throughout the day. In one aspect, the resources are different chip sets in different mother board sockets. In one aspect, provisioning of the other components (e.g., cooling, power supply, network bandwidth) in the multimode server is not adequate for both computing resources to run simultaneously.

### BACKGROUND

Generally, the servers selected for deployment in a data center can perform a wide range of computing tasks, but may not perform some specialized computing tasks very efficiently. For example, video intensive compute projects are better performed on a server with powerful GPU and video encoders. An enterprise server may be able to perform some video related work through the CPU, but the work may be inefficient. On the other hand, a server designed for video related work may perform general computing projects inefficiently.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the present invention relate to a multimode gaming server with different types of computing resources provided within the server. The different computing resources can be optimized for different computing tasks. For example, a first type of resource can be optimized for producing high definition graphics and a second type of resource for enterprise computing. Each resource may be activated or deactivated as demand for different computing tasks change throughout the day. In one aspect, the resources are different chip sets in different mother board sockets. In one aspect, provisioning of the other components (e.g., cooling, power supply, network bandwidth) in the multimode server is not adequate for both computing resources to run simultaneously.

In one aspect, the cooling capacity for the server is intentionally sized to be incapable of providing enough cooling to maintain an acceptable operational temperature for the multimode server, if all of the computing resources in the server are simultaneously in an active processing mode. The data center's control fabric can maintain an acceptable operating temperature within the server by assigning workloads to only one type of computing resources within the multimode server at a given point in time. For example, at any given time only the gaming optimized compute resource in a server may be assigned a workload and be in an active processing state. The remaining compute resources in the servers are set to a low-power state.

In one aspect, different computing resources within the multimode server have a similar maximum power usage when in an active processing mode. For example, a gaming optimized resource (e.g., a GPU and specialty CPU) having a maximum power usage of 150 W can be deployed in the same multimode server as an enterprise CPU having a 150 W capacity.

In one aspect, computing resources are selected for inclusion in a multimode server according to anticipated peak periods of usage. Resources designed for specialized workload having a peak period of usage that differs from each other can be included in a multimode gaming server. For example, a first type of computing resources associated with a specialized workload with peak hours from 4 PM to 12 PM can be matched with a second type of computing resource having a specialized workload with peak hours from 6 AM to 2 PM. In other words, during a given period either a first type or a second type of computing resource within a server will be in a high demand.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the invention;

FIG. 2 is a diagram depicting a gaming environment, in accordance with an aspect of the present invention;

FIG. 3 is a diagram depicting a remote gaming environment having one or more data centers with an nonhomogeneous arrangement of gaming servers and general purpose servers, in accordance with an aspect of the present invention;

FIG. 4 is a diagram depicting an arrangement of multimode gaming servers in various modes, in accordance with an aspect of the present invention;

FIG. 5 is a diagram depicting a mother board with active gaming resources, in accordance with an aspect of the present invention;

FIG. 6 is a diagram depicting a mother board with active general purpose resources, in accordance with an aspect of the present invention; and

FIG. 7 is a diagram depicting a method for managing workloads within a data center, in accordance with an aspect of the present invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention relate to a multimode gaming server with different types of computing resources provided within the server. The different computing resources can be optimized for different computing tasks. For example, a first type of resource can be optimized for producing high definition graphics and a second type of resource for enterprise computing. Each resource may be activated or deactivated as demand for different computing tasks change throughout the day. In one aspect, the resources are different chip sets in different mother board sockets. In one aspect, provisioning of the other components (e.g., cooling, power supply, network bandwidth) in the multimode server is not adequate for both computing resources to run simultaneously.

In one aspect, the cooling capacity for the server is intentionally sized to be incapable of providing enough cooling to maintain an acceptable operational temperature for the server, if all of the computing resources in the server are simultaneously in an active processing mode. The data center's control fabric can maintain an acceptable operating temperature within the server by assigning workloads to only one type of computing resources within the multimode server at a given point in time. For example, at any given time only the gaming optimized compute resource in a server may be assigned a workload and be in an active processing state. The remaining compute resources in the servers are set to a low-power state.

In one aspect, different computing resources within the multimode server have a similar maximum power usage when in an active processing mode. For example, a gaming optimized resource (e.g., a GPU and specialty CPU) having a maximum power usage of 150 W can be deployed in the same multimode server as an enterprise CPU having a 150 W capacity. Even though the total power usage of the two types of computing resources is similar, the distribution of power usage in the resource can differ greatly. For example, the gaming optimized resource may have a graphics processing unit (“GPU”) that uses 100 W and a central processing unit (“CPU”) that uses 50 W. The enterprise resource may not have a GPU, but could have a more powerful CPU that consumes 150 W.

In one aspect, computing resources are selected for inclusion in a multimode server according to anticipated peak periods of usage. Resources designed for specialized workload having a peak period of usage that differs from each other can be included in a multimode gaming server. For example, a first type of computing resources associated with a specialized workload with peak hours from 4 PM to 12 PM can be matched with a second type of computing resource having a specialized workload with peak hours from 6 AM to 2 PM. In other words, during a given period either a first type or a second type of computing resource within a server will be in a high demand.

As used herein, a “gaming optimized computing resource” is adapted to output a rendered video game image to a client device, such as a game console. The video game image may be rendered as a streaming video communicated to the client. In order to render a high quality video game image, a gaming optimized computing resource can have a graphics processing unit that is more powerful than a graphics processing unit, if any, found in a general-purpose computing resource. The gaming optimized computing resource may also have dedicated video encoding capabilities.

Power consumption can be used as a proxy for a processor's capabilities. In one aspect, a gaming optimized computing resource can be defined by the inclusion of a GPU that consumes greater than a threshold percentage of power used by the game optimized computing resource during peak power consumption. In one aspect, the threshold percentage of power is greater than 40% of peak power, for example greater than 50%, for example greater than 60%, for example greater than 70%, or for example greater than 80%. For example, a GPU in a gaming optimized computing resource could use 100 W, with a total peak power usage (e.g., GPU and CPU) of 150 W in the gaming optimized server resource.

As used herein, the terms “general-purpose computing resource” or “general processing optimized computing resource” describes a resource designed to emphasize computing process typically associated with a central processing unit. General-purpose computing resources can be capable of performing specialized computing processes, but may not be optimized for that purpose. For example, a CPU can perform graphics processing less efficiently than the same or similar tasks can be performed by a GPU.

Aspects of the present invention may transition various types of computing resources between different power modes or states. As used herein, the term “low-power mode” means a resource is presently operating at less than 20% of the resource's maximum rate of power. As an example, a resource in low-power mode may be shut off at the motherboard socket, but able to respond to a power-on command.

As used herein, the phrase “active processing mode” means a computing resource is actively processing a computing workload. A computing resource in active processing mode can be using greater than 20% of the resource's maximum rated power.

Having briefly described an overview of aspects of the invention, an exemplary operating environment suitable for use in implementing aspects of the invention is described below.

### Exemplary Operating Environment

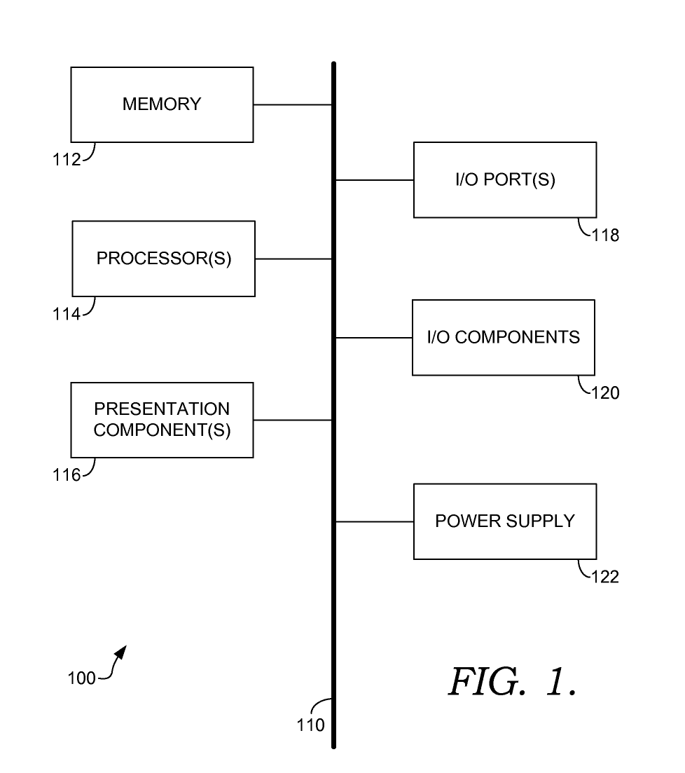

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Online Gaming Environment

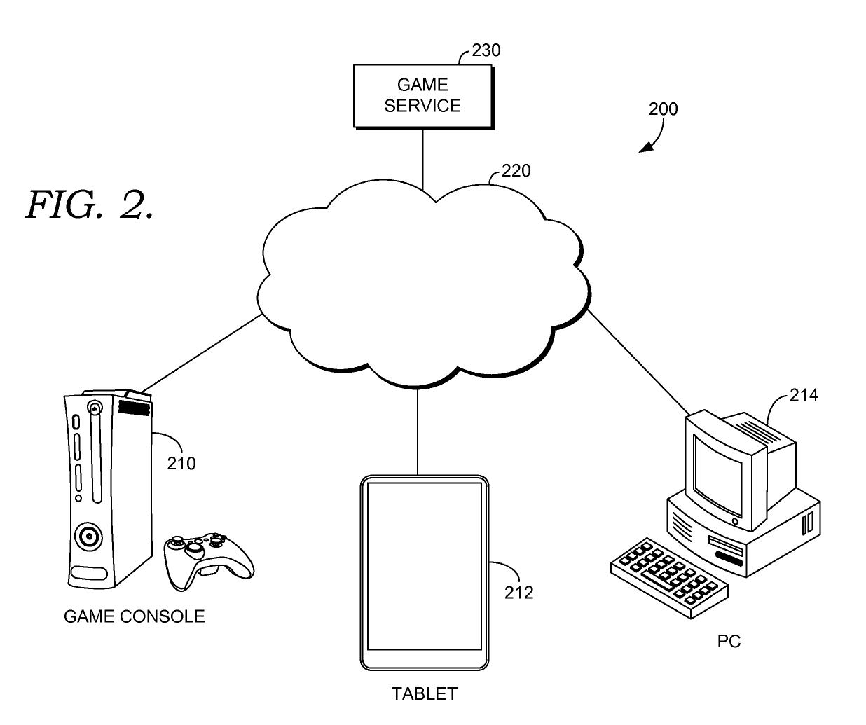

Turning now to FIG. 2, an online gaming environment 200 in which a multimode gaming servers may be deployed within a data center is shown, in accordance with an embodiment of the present invention. The online gaming environment 200 comprises various game clients connected through a network 220 to a game service 230. Exemplary game clients include a game console 210, a tablet 212, and a personal computer 214. Use of other game clients, such as smart phones, are also possible. The game console 210 may have one or more game controllers communicatively coupled to it. In one embodiment, the tablet 212 may act as an input device for a game console 210 or a personal computer 214. In another embodiment, the tablet 212 is a stand-alone game client. Network 220 may be a wide area network, such as the Internet.

Game service 230 comprises multiple computing devices communicatively coupled to each other. In one embodiment, the game service 230 is implemented using one or more data centers that comprise multimode gaming servers. The data centers may be spread out across various geographic regions including cities throughout the world. In this scenario, the game clients may connect to the closest data centers. Embodiments of the present invention are not limited to this setup.

The game service 230 allows the game to be executed within the computing devices provided by the game service 230. A communication session between the game service and game clients carries input traffic to the game service 230 and returns a rendered game image. In this embodiment, a computing device that is part of the game service executes the video game code using a control stream generated by input devices associated with the various game clients. The rendered video game is then communicated over the network to the game client where the rendered game is output for display.

The game service 230 may be provided by a data center that uses a combination of gaming optimized servers to execute the game and render a video game image. The gaming optimized servers may be deployed with multimode gaming servers. When a suitable task is not available for the multimode gaming servers, the gaming CPU and GPU within the multimode gaming servers can be placed in a low-power mode and the non-gaming optimized CPU activated.

### Exemplary Game Service

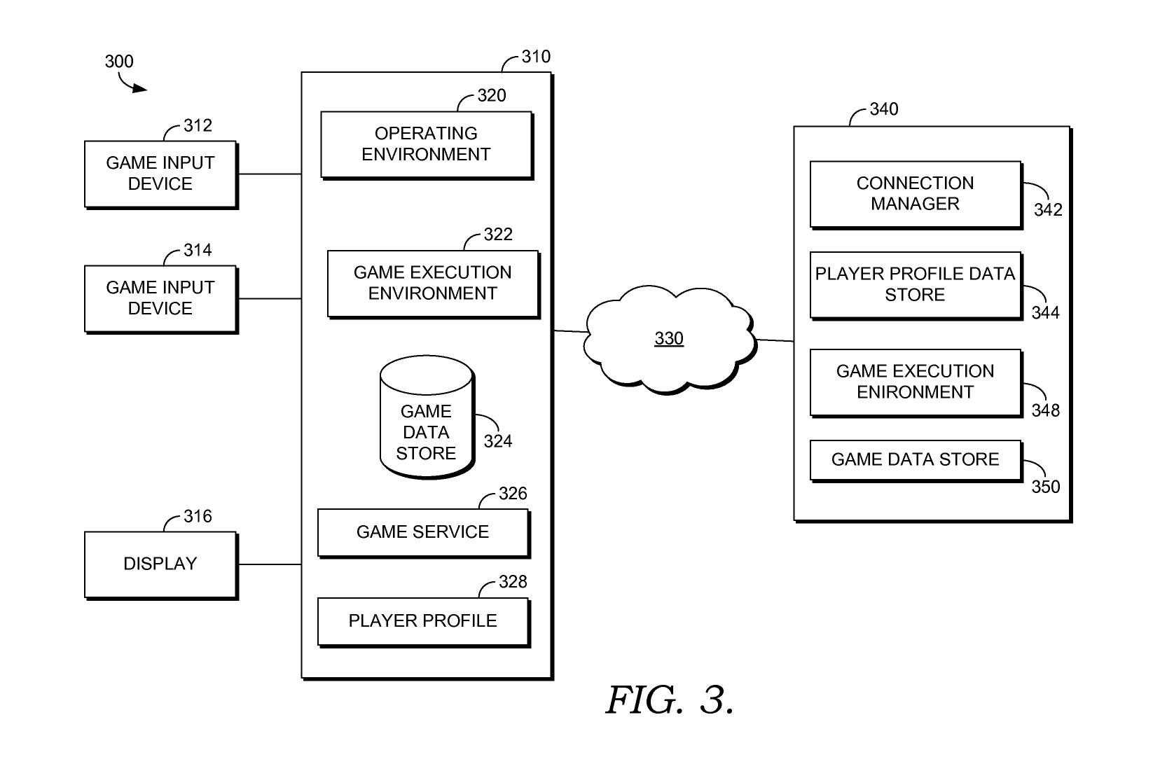

Turning now to FIG. 3, an exemplary remote gaming environment 300 is shown, in accordance with an embodiment of the present invention. The gaming environment 300 includes a game client 310 that is shown communicatively coupled to a game service 340 through a network 330. The gaming service may use one or more multimode gaming servers to accommodate peak gaming demand.

In one embodiment, the network may be the Internet. The game client 310 is connected to a first game input device 312, a second game input device 314, and a display 316. Exemplary game input devices include game pads, keyboards, a mouse, a touch pad, a touch screen, a microphone for receiving voice commands, a depth camera, a video camera, a keyboard, and a trackball. Embodiments of the present invention are not limited to these input devices. The display device 316 is capable of displaying video game content. For example, the display 316 may be a television or computer screen. In another embodiment, the display 316 is a touch screen integrated with the game client 310.

The game client 310 is a computing device that is able to execute video games. The game client 310 could be a tablet or a laptop computer. In another embodiment, the game client 310 is a game console and the display 316 is a remote display communicatively coupled to the game console. The game client 310 includes an operating environment 320, a game execution environment 322, a game data store 324, a game service client 326, and a player profile data store 328.

The operating environment 320 may be provided by an operating system that manages the hardware and provides services to application running on the game client 310. The operating environment may allocate client resources to different applications as part of the game migration. For example, the operating environment may give control of the display to the game execution environment 322 once game play is migrated to the game client 310.

The game execution environment 322 comprises the gaming resources on the client 310 required to execute instances of a game or a game preview. The game execution environment 322 comprises active memory along with computing and video processing. The game execution environment 322 receives gaming controls and causes the game to be manipulated and progressed according to its programming In one embodiment, the game execution environment 322 outputs a rendered video stream that is communicated to the display 316.

The game data store 324 stores downloaded games, game previews, and partially downloaded games.

The game service client 326 is a client application that displays rendered video game images received from the game service 340. The game service client 326 may also process game input and change it into an easily uploadable format that is communicated to the game service 340. The game service client 326 may also scale the rendered video game images received from the service 340 to a size optimized for display 316.

The player profile data store 328 stores player profile information for individual games. The player profile information may also save tombstones or game-saved data for individual games, including previews. Both the game-save file and the tombstone record game progress. The game execution environment 322 then reads the game-saved data to start the game where the player left off on the server. The opposite scenario is also possible where the game-saved data and player profile information is uploaded from the game client 310 to the game service 340 to initiate the game.

The game service 340 comprises a connection manager 342, a player profile data store 344, a game execution environment 348, and a game data store 350. Though depicted as a single box, the game service 340 could be implemented in a data center that comprises numerous machines, or even several data centers.

The connection manager 342 builds a connection between the client 310 and the service 340. The connection manager 342 may also provide various authentication mechanisms to make sure that the user is authorized to access the game service 340. The connection manager 342 may also analyze the bandwidth available within a connection and throttle the download of a game during game play to make sure that game play is not degraded.

The player profile data store 344 may work in conjunction with the connection manager 342 to build and store player information. Part of the player profile may comprise demographic and financial information such as a player's name, address and credit card information or other mechanism for paying for or purchasing games and experiences provided by the game service.

In addition, the player profile data store 344 may store a player's progress within an individual game. As a player progresses through a game or game preview, the player's score and access to game levels may be stored. Further, the player profile data store 344 may store information about individual player preferences such as language preferences. Information regarding a player's game client and speed of the network connection may also be stored and utilized to optimize the gaming experience. For example, in one embodiment, when a geographically proximate data center is busy, players with higher latency Internet connections may be preferentially connected to proximate data centers while players with lower latency connections may be connected to data centers that are further away. In this way, the players with the network connections that are best able to handle the additional latency are connected to data centers that create additional latency because of their location.

The player profile data store 344 may also store a usage history for the individual player. A player's history of purchasing games, sampling games, or playing games through a game service that does not require the purchase of the games may be stored. The usage information may be analyzed to suggest games of interest to an individual player. In one embodiment, the purchase history may include games that are not purchased through the game service. For example, the purchase history may be augmented by the player entering in a key from a game purchased in a retail store. In some embodiments, the player may then have access to that game both on their game client 310 and through the game service when they are no longer at their game client.

The game execution environment 348 comprises the gaming resources required to execute instances of a game. These are the resources described previously that are managed by the game manager 352 and other components. The game execution environment 348 comprises active memory along with computing and video processing. The game execution environment 348 receives gaming controls through an 110 channel and causes the game to be manipulated and progressed according to its programming. In one embodiment, the game execution environment 348 outputs a rendered video stream that is communicated to the game client. In other embodiments, the game execution environment 348 outputs game geometry, or other representations, which may be combined with local objects on the gaming client to render the gaming video.

The game data store 350 stores available games. The games may be retrieved from the data store and activated through an active memory. The game data store 350 may be described as passive or secondary memory. In general, games may not be played off of the game data store 350. However, in some embodiments, the secondary memory may be utilized as virtual memory, in which case portions of the game data store 350 may also serve as active memory. This illustrates that active memory is not necessarily defined by a particular hardware component, but is defined by the ability of the game resources to actively manipulate and access objects within the memory to execute the game.

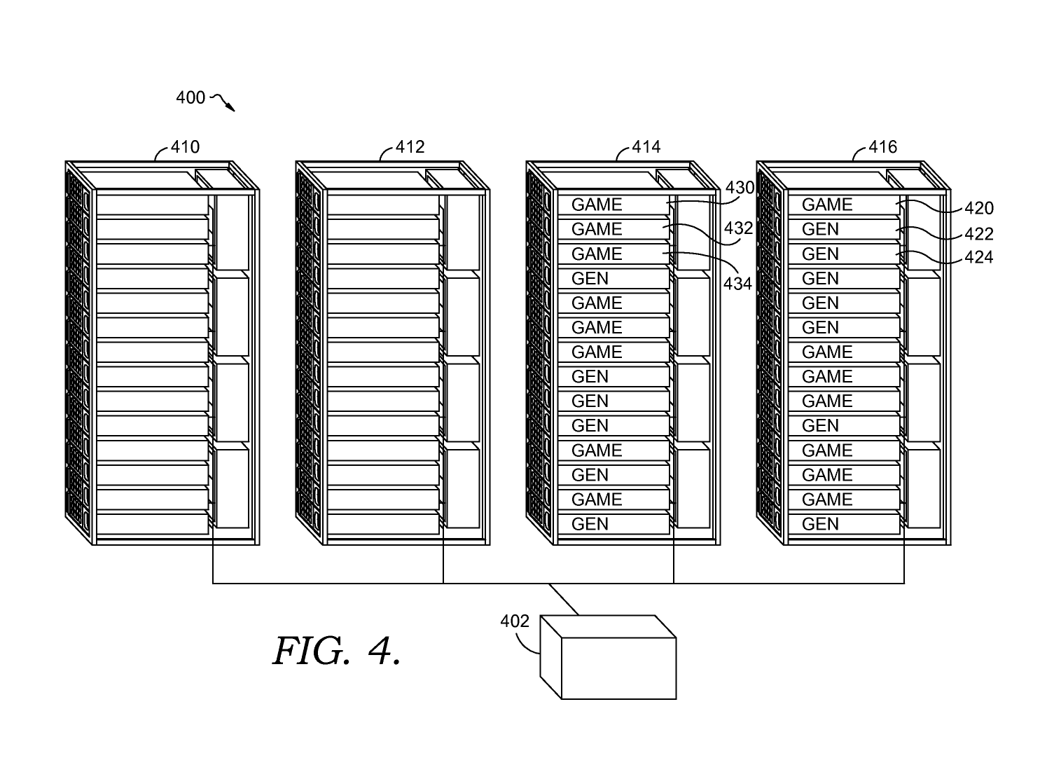

Turning now to FIG. 4, an arrangement of multimode gaming servers within a data center 400 is shown, in accordance with an aspect of the present invention. The arrangement comprises rack 410, rack 412, rack 414, and rack 416. Four racks are shown for the sake of simplicity; an actual implementation could include tens, hundreds, or thousands of racks deployed within a data center. Each rack can comprise a quantity of servers, power distribution equipment, and networking equipment. In one arrangement, a networking cable is run to a router/switch within the rack. Each server in the rack then connects to the router. Similarly, power may be run to a power distribution station associated with the rack. Each server is then coupled to the power distribution station.

Additionally, each rack can include cooling equipment, such as fans. In one arrangement, a fan wall is provided behind the servers to draw air through the servers. In a vertical cooling arrangement, one or more fans are located above or below the rack to facilitate airflow to the servers within the rack. The cooling equipment can also include thermocouples and other sensors that measure temperature, pressure, and air flow throughout the rack. The rack may include one or more fixed or adjustable baffles to distribute air where needed for cooling.

A control fabric 402 is communicatively coupled to the racks and computing devices within the racks. The control fabric 402 manages the state of each multimode gaming server. For example, the control fabric 402 can transition a multimode server between modes by activating a first type of computing resource and deactivating a second type of computing resource. The control fabric 402 can distribute workloads to computing devices. The control fabric 402 can also manage cooling equipment within the racks. For example, the control fabric 402 can lower fan speed within a rack when the servers within the rack are in a low power mode.

Racks 414 and 416 illustrate multimode servers in a mixture of modes. Aspects of the present invention are not limited to mixing modes within a data center unit, such as a rack chassis. In one aspect, all multimodal gaming servers within a data center unit are operating in the same mode. As FIG. 4 illustrates, a mixture of modes within a rack is also possible.

Illustratively, rack 416 includes multimode server 420 in game mode, multimode server 422 in general processing mode, and multimode server 424 in general processing mode. Illustratively, rack 414 includes multimode server 430 in game mode, multimode server 432 in game mode, and multimode server 434 in game mode. In one aspect, the computing devices within a rack have a homogeneous hardware configuration that allows them to switch between a gaming optimized mode and a non-gaming optimized mode.

The multimode servers can be transitioned between a gaming optimization and general-purpose optimization by activating different computing resources within the server. In one aspect, the general-purpose resources and game-optimized resources have peak usage periods that do not significantly overlap. Racks with an arrangement of multimode gaming servers, such as racks 414 and 416, may be deployed within a data center in combination with racks of single mode servers optimized for a single function, such as gaming. The quantity of single mode servers may be specified to accommodate base demand for the computing service provided by an optimized server. The deployment of single mode servers to meet base demand allows the single mode servers to be active above a threshold amount of time on average. For example, an amount of single mode servers deployed may be limited to those able to be active, on average, 80% of a day. Multimode servers can be used during peak usage periods to accommodate demand in combination with single mode servers optimized for the work load, such as gaming.

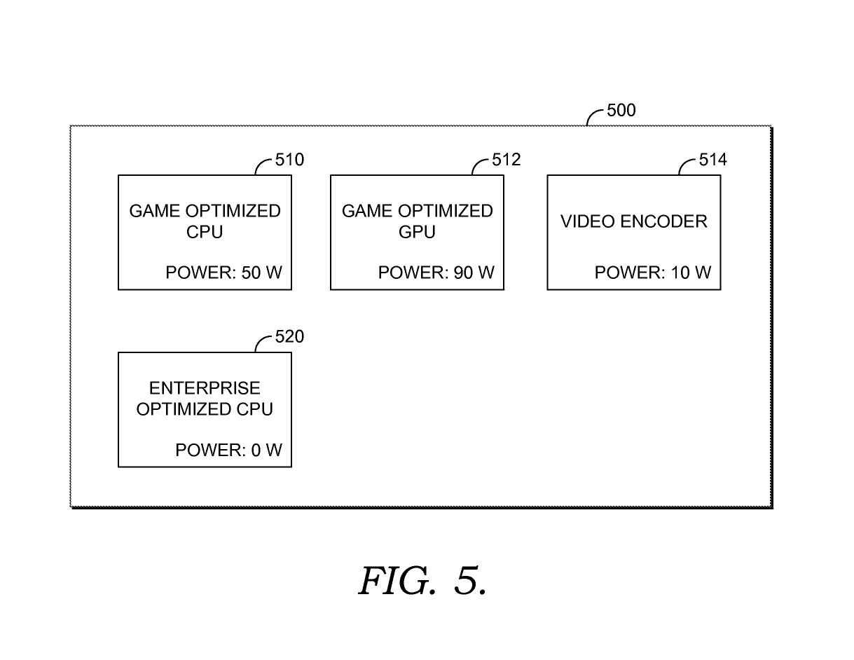

Turning now to FIG. 5, different types of resources within a multimode server are shown, in accordance with an aspect of the present invention. The multipurpose server includes motherboard 500. The motherboard 500 includes a first type of computing resource optimized for gaming. The first type of computing resource comprises a game optimized CPU 510, a game-optimized GPU 512, and a video encoder 514. This illustrates that a computing resource, as used herein, can comprise multiple hardware items. Also, though not shown, the computing resources may include memory and other components that support the resource. For example, a CPU can have dedicated DRAM memory. Aspects of the invention are not limited to use with a separate video encoder. A video encoder could be part of a CPU or GPU.

In one aspect, the game optimized CPU 510 and game-optimized GPU 512 are the same chips as found in a commercially available game console. Exemplary game consoles include the Xbox 360, Sony's PlayStation® family, Xbox One, and Nintendo's Wii™, and such. The hardware configuration associated with the game optimized computing resources can be configured to allow games written for a commercially available game console to run on the multimode server without modification to the game code and to interact with the hardware in the same way the games interact with hardware in the game console. For example, a process performed by a game console's GPU can be performed by the game-optimized computing resource's GPU.

The game optimized CPU 510, the game-optimized GPU 512, and the video encoder 514 can all be coupled to sockets within the motherboard. In one aspect, a computing resource is deactivated for transition to a low power mode by turning off the socket to which the resource is attached.

The general-purpose computing resource on motherboard 500 comprises enterprise-optimized CPU 520. In game mode, as shown in FIG. 5, the enterprise-optimized CPU 520 is drawing 0 W. In contrast, the game optimized CPU 510 is drawing 50 W, the game-optimized GPU 512 is drawing 90 W, and the video encoder 514 is drawing 10 W for a total use of 150 W in game mode.

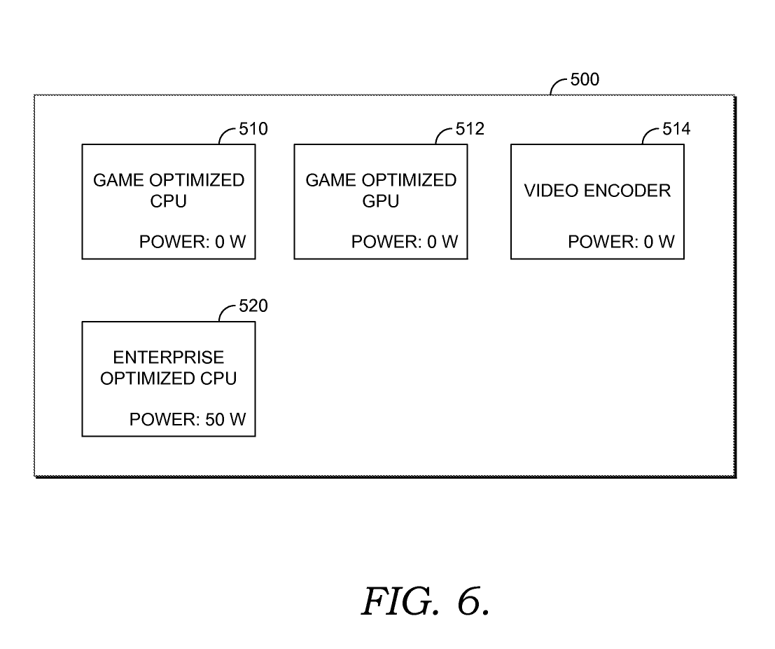

Turning now to FIG. 6, power use in general purpose compute mode is illustrated, in accordance with an aspect of the present invention. Now the game optimized CPU 510, the game-optimized GPU 512 and a video encoder 514 are all drawing 0 W. In contrast, the enterprise-optimized CPU 520 is drawing 150 W. In one aspect, the rated power consumption of computing resources associated with different modes is substantially equal. In this case, the computing resources associated with the gaming mode draw the same amount of power as the computing resources associated with the enterprise, or general compute mode. In one aspect, the cooling system for a multimode server is only capable of providing a knot cooling for one type of computing resource to be active at a given point in time.

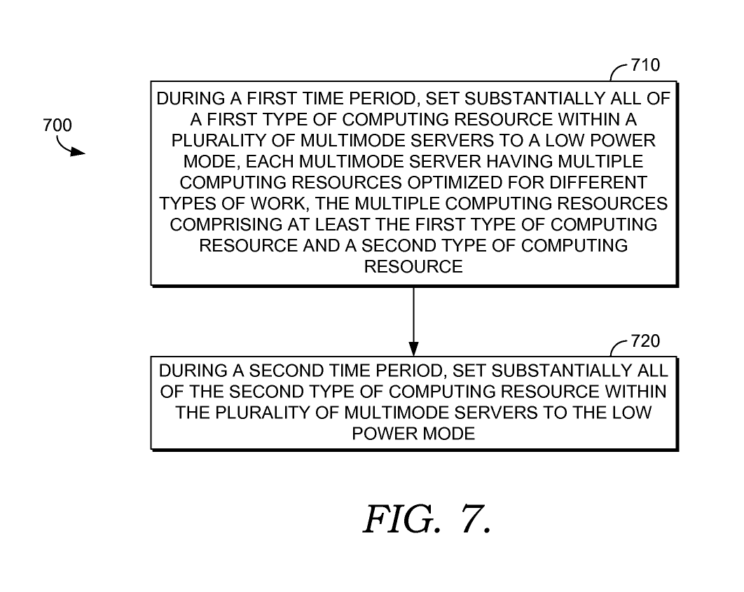

Turning now to FIG. 7, a method 700 for managing workloads within a data center is provided, in accordance with an aspect of the present invention. Method 700 may be performed by a control fabric that manages workloads within a data center.

At step 710, substantially all of a first type of computing resource within a plurality of multimode servers are set to a low powered mode during a first time period. Each multimode server has multiple computing resources optimized for different types of work. The multiple computing resources comprise at least the first type of computing resource and a second type of computing resource. In one aspect, the first period of time corresponds to a low demand period for a workload the first type of computing resource is optimized to process. For example, a low demand period for a gaming workload may occur during the day and gaming optimized servers may be set to a low power mode during this period of time.

At step 720 substantially all of the second type of computing resource within the plurality of multimode servers are set to the low power mode at a second time period. The first and second time periods do not substantially overlap in one aspect. The nonoverlapping time periods allow the first type of computing resource and a second type of computing resource to satisfy peak demand for the computing loads they are optimized to handle.

The type of computing resource that is active within an individual multimode server can be adjusted based on workload demand. As the supply of a first type of workload increases, resources adapted to process the first type of workload can be activated. As demand for different types of workload changes, a mixture of states may be present in the plurality of multimode servers. For example, all the multimode servers could be set to process a first type of workload, a third of the multimode servers could be set to process a first type of workload, half of the multimode servers could be set to process a first type of workload, or none of the multimode servers could be set to process a first type of workload. Multimode servers that are not set to handle the first type of workload could be set to use a different type of workload.

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. A multimode server comprising a gaming optimized computing resource having a first hardware configuration and a general processing optimized computing resource having a second hardware configuration that is different from the first hardware configuration, wherein the gaming optimized computing resource and the general processing optimized computing resource are power balanced to use a substantially equal amount of power at peak power, and wherein the multimode server comprises a control to activate either the gaming optimized computing resource or the general processing optimized computing resource at a given point in time, but not both simultaneously.

2. The multimode server of claim 1, wherein the gaming optimized computing resource is designed for a first workload with a peak usage during a first time period and the general processing optimized computing resource is designed for a second workload with a peak usage during a second time period that does not substantially overlap with the first time period.

3. The multimode server of claim 1, wherein the gaming optimized computing resource has a graphics processing unit (“GPU”) and a central processing unit (“CPU”), and wherein a maximum power usage of the GPU comprises more than 40% of the gaming optimized computing resource's maximum power usage.

4. The multimode server of claim 1, wherein a power source provided to the multimode server does not supply enough power to run the gaming optimized computing resource and the general processing optimized computing resource simultaneously.

5. The multimode server of claim 1, wherein at least part of the gaming optimized computing resource is connected to a first socket on a mother board and at least part of the general processing optimized computing resource is connected to a second socket on the mother board.

6. The multimode server of claim 1, wherein the gaming optimized computing resource comprises a CPU that is also used in a commercially available game console and a GPU that is also used in the commercially available game console.

7. The multimode server of claim 1, wherein an amount of cooling provided to the multimode server does not exceed 70% of what is adequate to facilitate simultaneous operation of the gaming optimized computing resource and the general processing optimized computing resource.

8. A method for managing workloads within a data center, the method comprising:
during a first time period, setting substantially all of a first type of computing resource within a plurality of multimode servers to a low power mode, each multimode server having multiple computing resources optimized for different types of work, the multiple computing resources comprising at least the first type of computing resource and a second type of computing resource; and
during a second time period, setting substantially all of the second type of computing resource within the plurality of multimode servers to the low power mode,
wherein the second time period does not substantially overlap with the first time period.

9. The method of claim 8, wherein said setting the first type of computing resource to the low power mode comprises deactivating one or more motherboard sockets to which the first type of computing resource is attached.

10. The method of claim 8, wherein the first type of computing resource is designed for a first workload with a peak usage during the first time period and the second type of computing resource is designed for a second workload with a peak usage during the second time period.

11. The method of claim 8, wherein the first type of computing resource is a game optimized computing resource.

12. The method of claim 8, wherein the first type of computing resource and the second type of computing resource generate a substantially similar amount of heat when in use.

13. The method of claim 12, wherein a maximum amount of available cooling for the plurality of multimode servers is about 60% of an amount needed to adequately cool all the plurality of multimode servers when both the first type of computing resource and the second type of computing resource are in an active processing mode.

14. The method of claim 8, wherein the first type of computing resource outputs a rendered video game image over a wide area network to a remotely located gaming device.

15. A data center system comprising:
a data center having a total quantity of multimode servers, each multimode server comprising at least a gaming optimized computing resource and a non-gaming optimized computing resource; and
a controller to set a mode in each of the total quantity of multimode servers to ensure that the gaming optimized computing resource in an individual multimode server and the non-gaming optimized computing resource in the individual multimode server are not both in an active processing mode simultaneously.

16. The data center system of claim 15, wherein the non-gaming optimized computing resource and the gaming optimized computing resource output a substantially similar amount of heat when running in the active processing mode.

17. The data center system of claim 15, further comprising a cooling system for the total quantity of multimode servers, the cooling system having a maximum cooling capacity that is not adequate to maintain operational temperatures within the total quantity of multimode servers when more than 70% of a total quantity of the gaming optimized computing resource and the non-gaming optimized computing resource are in an active processing mode.

18. The data center system of claim 17, wherein the cooling system is a vertical cooling system provided by one or more fans located on top of a rack or underneath the rack.

19. The data center system of claim 15, wherein the gaming optimized computing resource and the non-gaming optimized computing resource generate a substantially similar amount of heat when in use.

20. The data center system of claim 15, wherein the gaming optimized computing resource has a graphics processing unit (“GPU”), a central processing unit (“CPU”), and a video encoder, and wherein a maximum power usage of the GPU comprises more than 40% of the gaming optimized computing resource's maximum power usage.
